(19) United States
(12) Patent Application Publication
(10) Pub. No.: US 2004/0106424 A1
(43) Pub. Date: Jun. 3, 2004

(54) Reproduction apparatus, output apparatus and method for controlling power consumption

(75) Inventor: Junichi Yoshizawa, Ome-shi (JP)

Correspondence Address: FOLEY & LARDNER, 2029 CENTURY PARK EAST, SUITE 3500, LOS ANGELES, CA, 90067

(73) Assignee: KABUSHIKI KAISHA TOSHIBA

(21) Appl. No.: 10/667,678

(22) Filed: Sep. 22, 2003

(30) Foreign Application Priority Data
Sep. 30, 2002 (JP) 2002-287119

(51) Int. Cl. H04B 7/00; H04Q 7/20

(52) U.S. Cl. 455/522

(57) ABSTRACT

A power consumption control method is applied to a communication system including a reproduction apparatus capable of reproducing content data and an output apparatus capable of outputting data based on the reproduced content data. The content data reproduced by the reproducing apparatus is transmitted to the output apparatus through a radio communication interface. At least one of the reproducing apparatus and the output apparatus is transitioned from an ordinary operation mode to a low-power consumption operation mode through the radio communication interface, when a data reproduction stop request is made in another of the reproducing apparatus and the output apparatus.

### CROSS-REFERENCE TO RELATED APPLICATIONS

This application is based upon and claims the benefit of priority from prior Japanese Patent Application No. 2002-287119, filed Sep. 30, 2002, the entire contents of which are incorporated herein by reference.

### BACKGROUND OF THE INVENTION

1. Field of the Invention

The present invention relates to a reproduction apparatus having a content data reproducing function, an output apparatus having a data outputting function and a method for controlling power consumption. More particularly, the present invention relates to a method for controlling power consumption applied to a communication system, which transmits and receives content data through a radio communication interface.

2. Description of the Related Art

In recent years, as radio technologies in personal areas, such as Bluetooth™ and HomeRF™ have been developed, consideration has been given to adoption of a radio interface to various electronic devices (e.g., personal computers, personal digital assistants, cellular phones) based on these radio technologies. Actually, such an interface has been adopted to some types of electronic device.

In particular, since Bluetooth costs are low and standardization organizations highly value its connectivity, it will become a standard technology for short-distance radio communication in the next generation. Bluetooth is one of technologies that are expected to be applicable to various fields, particularly to AV (audio/video) apparatuses.

AV data transmission to a wireless headphone is an application of Bluetooth to AV apparatuses (see, for example, Jpn. Pat. Appln. KOKAI Publication No. 2002-112383). According to this prior art, a wireless headphone is connected to a portable audio player or the like by means of the Bluetooth technology, so that a conventional cable is not required. As a result, a more conformable audio reproduction environment can be expected.

A portable apparatus called a wireless headset, utilizing infrared rays or high-frequency radio, has been published and already put into practical use. The Bluetooth wireless headset apparatus is vastly different from the conventional wireless headset in that the former employs a connection-type radio communication system (in which various data is transmitted and received while a logical connection is maintained), and the latter uses a connection-less-type radio communication in which a connection is not established (e.g., walkie talkie, broadcast transmission etc.). It is considered that this system has many advantages over the conventional system: for example, the applicability to various devices, the assurance of data reliability by a standard protocol, etc.

However, in an apparatus utilizing a connection-type communication system like Bluetooth, in order to maintain a logical connection, an RF section keeps executing data transmission and reception even in a period when audio data or the like is not being transmitted. Therefore, the apparatus always consumes a large amount of power. In this condition, the remaining battery level of the apparatus decreases rapidly, which is not desirable particularly for a portable apparatus.

### BRIEF SUMMARY OF THE INVENTION

Embodiments of the present invention may provide a reproduction apparatus, an output apparatus and a method for controlling power consumption, which reduces power consumption, while ease of the operation is maintained.

According to one aspect of the present invention, there is provided a power consumption control method applied to a communication system including a reproduction apparatus capable of reproducing content data and an output apparatus capable of outputting data based on the reproduced content data, the method comprising transmitting the content data reproduced by the reproducing apparatus to the output apparatus through a radio communication interface; and transitioning at least one of the reproducing apparatus and the output apparatus from an ordinary operation mode to a low-power consumption operation mode through the radio communication interface, when a data reproduction stop request is made in another of the reproducing apparatus and the output apparatus.

According to another aspect of the present invention, there is provided an output apparatus, comprising a radio communication interface; an output control unit configured to output data in accordance with content data transmitted from a reproduction apparatus through the radio communication interface; and a power control unit configured to control at least the reproduction apparatus to transition from an ordinary operation mode to a low-power consumption operation mode through the radio communication interface, when a data reproduction stop request is made.

According to still another aspect of the present invention, there is provided a reproduction apparatus, comprising a radio communication interface; a reproduction control unit configured to reproduce content data; a transmission control unit configured to transmit the content data reproduced by the reproduction control unit to an output apparatus through the radio communication interface; and a power control unit configured to control at least the output apparatus to transition from an ordinary operation mode to a low-power consumption operation mode through the radio communication interface, when a data reproduction stop request is made.

Additional features and advantages of the invention will be set forth in the description which follows, and in part will be obvious from the description, or may be learned by practice of the invention. The features and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a block diagram showing a schematic configuration of a music reproduction apparatus according to an embodiment of the present invention;

FIG. 2 is a block diagram showing a schematic configuration of a headphone according to the embodiment;

FIG. 3 is a block diagram showing a function configuration of a system control section of the music reproduction apparatus shown in FIG. 1;

FIG. 4 is a block diagram showing a function configuration of a system control section of the headphone shown in FIG. 2;

FIG. 5 is a diagram showing procedures carried out between the music reproduction apparatus and the headphone before a connection-type communication link is established;

FIG. 6 is a flow chart showing an example of procedures to transition to a low-power consumption operation mode;

FIG. 7 is a flow chart showing an example of procedures to return from the low-power consumption operation mode to an ordinary operation mode;

FIG. 8 is a flow chart showing procedures in the music reproduction apparatus (master) when Sleep Mode 1 is set;

FIG. 9 is a flow chart showing procedures in the headphone (slave) when Sleep Mode 1 is set;

FIG. 10 is a flow chart showing procedures in the music reproduction apparatus (master) when Sleep Mode 2 is set;

FIG. 11 is a flow chart showing procedures in the headphone (slave) when Sleep Mode 2 is set;

FIG. 12 is a flow chart showing procedures in the headphone (master) when Sleep Mode 1 is set;

FIG. 13 is a flow chart showing procedures in the music reproduction apparatus (slave) when Sleep Mode 1 is set;

FIG. 14 is a flow chart showing procedures in the headphone (master) when Sleep Mode 2 is set; and

FIG. 15 is a flow chart showing procedures in the music reproduction apparatus (slave) when Sleep Mode 2 is set.

### DETAILED DESCRIPTION OF THE PREFERRED EMBODIMENTS

Embodiments of the present invention will now be described with reference to the accompanying drawings.

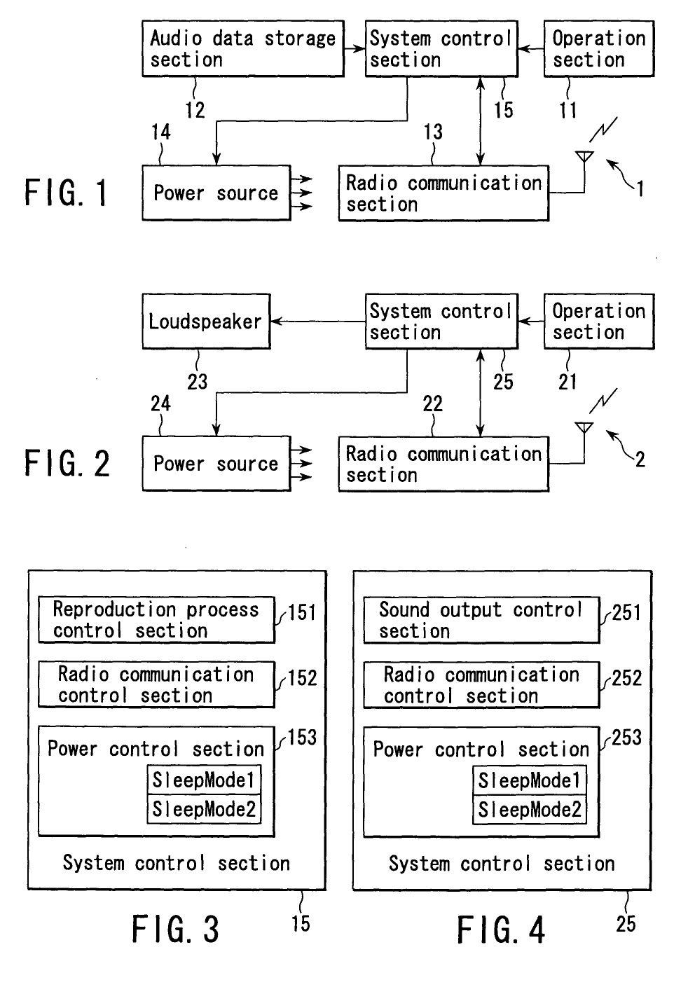

FIG. 1 is a block diagram showing a schematic configuration of a music reproduction apparatus according to an embodiment of the present invention. FIG. 2 is a block diagram showing a schematic configuration of a headphone according to the embodiment.

A music reproduction apparatus 1 shown in FIG. 1 is, for example, a portable music player. It has an operation section 11, an audio data storage section 12, a radio communication section (interface) 13, a power source (and a power controller) 14 and a system control section 15. The music reproduction apparatus 1 may be an electronic device, such as a personal digital assistant or a cellular phone.

The operation section 11 has a power (on/off) button, a group of reproduction processing buttons (a reproduction (play) button, a stop button, a pause button, and fast-forward and fast-reverse buttons). When a button is depressed, the corresponding command is supplied to the system control section 15.

The audio data storage section 12 is a non-volatile memory medium storing audio data. It may be a CD (compact disk), an MD (mini disk), a semiconductor memory, etc.

The radio communication section 13 is a communication module based on a radio communication interface, which realizes a connection-type radio communication system (i.e., a radio communication system in which audio data or the like is transmitted and received in a state where a logical connection is maintained). In this embodiment, Bluetooth is used as the radio communication interface. According to Bluetooth, audio data or the like is transmitted after negotiations between apparatuses are carried out and a logical connection therebetween is established. In this case, communication can be performed bidirectionally. Any interface other than Bluetooth (for example, a wireless LAN) can be used as the radio communication interface, if it is a connection-type radio communication system.

The power source 14 has a battery, which supplies electric power to the respective components of the music reproduction apparatus 1.

The system control section 15 corresponds to a CPU (central processing unit), which controls the overall operations of the music reproduction apparatus 1, and a memory. It executes power consumption control and the like in accordance with predetermined programs.

As shown in FIG. 3, the system control section 15 has various function sections, such as a reproduction process control section 151, a radio communication control section 152 and a power control section 153.

The reproduction process control section 151 executes reproduction or stops reproduction of audio data stored in the audio data storage section 12 in accordance with various commands issued by depression of the reproduction button, the stop button, the pause button, etc. in the operation section 11. The reproduced audio data is transmitted to another electronic device (here, a headphone 2) through the radio communication control section 152.

The radio communication control section 152 corresponds to software that controls the radio communication section (communication module) 13. It transmits the reproduced audio data to the other electronic device (the headphone 2) or transmits/receives various commands to/from the electronic device.

The power control section 153 controls the on/off state of the power source 14 in accordance with a command corresponding to depression of the power button of the operation section 11. In addition, it controls the power source 14 (or the power controller) in accordance with a predetermined command generated in the music reproduction apparatus 1 or a predetermined command transmitted from the other electronic device (here, the headphone 2). As a result, the power control section 153 causes the music reproduction apparatus 1 to transition from an ordinary power consumption operation mode to a low-power consumption operation mode and vice versa. The power control section 153 also has a function of transmitting, through the radio communication section 13, a command to cause the other electronic device (the headphone 2) to transition from an ordinary power consumption operation mode to a low-power consumption operation mode and vice versa in accordance with a predetermined command generated in the music reproduction apparatus 1.

The low-power consumption operation mode means a state in which power consumption involved in the radio communication is reduced. It includes a first mode (Sleep Mode 1) in which the radio communication connection is maintained, and a second mode (Sleep Mode 2) in which the connection is cut off. Details of Sleep Modes 1 and 2 will be described later.

The headphone 2 shown in FIG. 2 is, for example, a portable wireless headphone. It has an operation section 21, a radio communication (interface) section 22, a loudspeaker 23, a power source (and a power controller) 24and a system control section 25. A headset or earphones can be used in place of the headphone.

The operation section 21 has operation buttons or switches, which are necessary to operate another electronic device (here, the music reproduction apparatus 1): a power (on/off) button, a group of reproduction processing buttons (a reproduction (play) button, a stop button, a pause button, and fast-forward and fast-reverse buttons). When a button is depressed, the corresponding command is supplied to the system control section 25.

The radio communication section 22 is a communication module based on a radio communication interface, which realizes a connection-type radio communication system (i.e., a radio communication system in which audio data or the like is transmitted and received in a state where a logical connection is maintained). In this embodiment, Bluetooth is used as the radio communication interface. Any interface other than Bluetooth (for example, a wireless LAN) can be used as the radio communication interface, if it is a connection-type radio communication system.

The loudspeaker 23 outputs sound in accordance with audio data transmitted from the other electronic device (the music reproduction apparatus 1) through the radio communication section 22.

The power source 24 has a battery, which supplies electric power to the respective components of the headphone 2.

The system control section 25 corresponds to a CPU (central processing unit), which controls the overall operations of the headphone 2, and a memory. It controls power consumption and the like in accordance with predetermined programs.

As shown in FIG. 4, the system control section 25 has various function sections, such as a sound output control section 251, a radio communication control section 252 and a power control section 253.

The sound output control section 251 receives audio data transmitted from the other electronic device (the music reproduction apparatus 1) through the radio communication section 22, and causes the loudspeaker 23 to output it as sound. The sound output control section 251 also has a function for transmitting, through the radio communication section 22, commands to instruct the other electronic device (the music reproduction apparatus 1) to execute or stop reproduction of audio data in accordance with various commands issued by depression of the reproduction button, the stop button, the pause button, etc. in the operation section 21.

The radio communication control section 252 corresponds to software that controls the radio communication section (communication module) 22. It transfers audio data transmitted from the other electronic device (the music reproduction apparatus 1) to the system control section 25, or transmits/receives various commands to/from the electronic device.

The power control section 253 controls the on/off state of the power source 24 in accordance with a command corresponding to depression of the power button of the operation section 21. In addition, it controls the power source 24 (or the power controller) in accordance with a predetermined command generated in the headphone 2 or a predetermined command transmitted from the other electronic device (the music reproduction apparatus 1). As a result, the power control section 253 causes the headphone 2 to transition from the ordinary power consumption operation mode to the low-power consumption operation mode and vice versa. The power control section 253 also has a function of transmitting, through the radio communication section 22, a command to cause the other electronic device (the music reproduction apparatus) to transition from the ordinary power consumption operation mode to the low-power consumption operation mode and vice versa in accordance with a predetermined command generated in the headphone 2.

Details of Sleep Modes 1 and 2 will be described later.

Procedures carried out between the music reproduction apparatus 1 and the headphone 2 before a connection-type communication link is established will be briefly described.

The steps executed before a connection by Bluetooth is established are classified into, for example, the following three stages:

Inquiry (Acquisition of an address (BD_ADDR) specific to a peripheral device);

Paging (Establishment of a connection to a desired BD_ADDR device at a link layer level); and

Service (Establishment of a connection at a desired service (application) level).

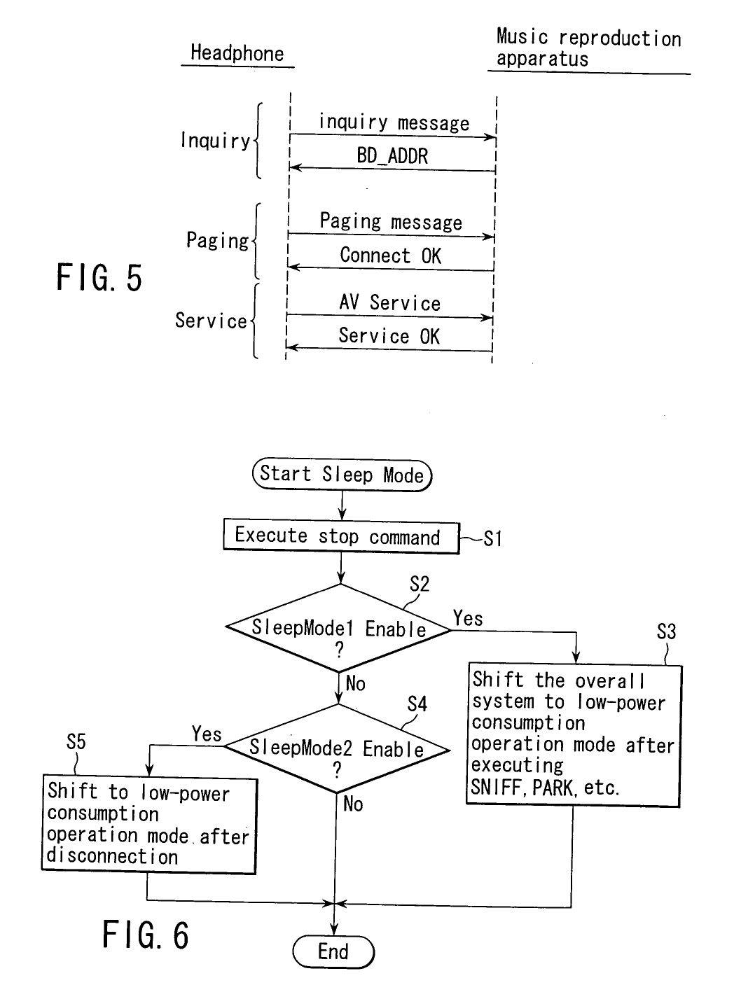

The above procedures are shown in FIG. 5. FIG. 5 shows an example, in which the headphone 2 is a master, and the music reproduction apparatus 1 is a slave.

The master transmits an “Inquiry” message, and obtains “BD_ADDR” from the slave. After the master has obtained “BD_ADDR”, it transmits a “Paging” message, and obtains a “Connection OK” message from the slave, whereby it establishes a connection of the link layer level. Then, the master transmits, for example, an “AV Service” message, obtains a “Service OK” message from the slave, whereby it establishes a connection of the service (application) level. Thereafter, the music reproduction apparatus can be operated on the bases of various AV processing commands.

Needless to say, the music reproduction apparatus 1 can be a master, while the headphone 2 can be a slave.

In the state where the connection is established as described above, assume that either the music reproduction apparatus 1 or the headphone 2 issues a stop command or a pause command during reproduction of music (that is, the stop button or the pause button is depressed). In this case, flow of AV data in an AV data channel is stopped by the stop command. The music reproduction apparatus 1 and the headphone 2 are set to the low-power consumption operation mode (Sleep Mode). Alternatively, if necessary, they are set to the low-power consumption operation mode, after a predetermined time is counted by a timer.

The low-power consumption operation mode according to this embodiment has the following two modes:

Sleep Mode 1: a mode to start a SNIFF mode or PARK mode with the connection maintained, when reproduction is stopped; and

Sleep Mode 2: a mode to cut the connection, when reproduction is stopped.

The user can select/set Sleep Mode 1 or 2 in at least one of the music reproduction apparatus 1 and the headphone 2. The set information is stored in a predetermined memory area, in which the selected mode is enabled.

An example of the procedures to transition to the low-power consumption operation mode will be described with reference to the flow chart shown in FIG. 6.

When the stop command is detected during reproduction (Step S1), it is determined whether Sleep Mode 1 or 2 is enabled (Steps S2 and S4). If Sleep Mode 1 is enabled (Yes in Step S2), the entire radio communication system is transitioned to the low-power consumption operation mode by setting the SNIFF mode or PARK mode (step S3). If Sleep Mode 2 is enabled (Yes in Step S4), the entire radio communication system is transitioned to the low-power consumption operation mode after the connection is cut off (Step S5).

In Sleep Mode 1, since only the minimum procedures to maintain the connection are performed, the power consumption can be considerably reduced. In Sleep Mode 2, since no procedure to maintain the connection is performed, the power consumption can be much more reduced than in Sleep Mode 1.

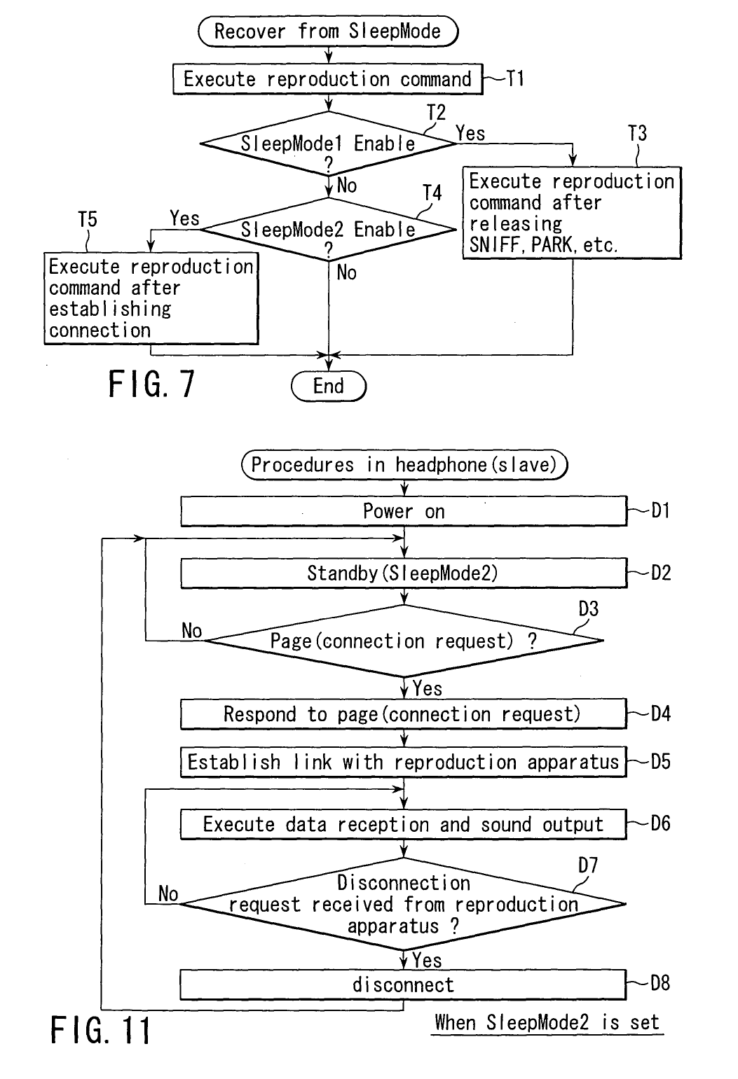

An example of procedures to recover from the low-power consumption operation mode to the ordinary operation mode will be described with reference to FIG. 7.

When a reproduction command is detected while the reproduction is stopped (Step T1), it is determined whether Sleep Mode 1 or 2 is enabled (Steps T2 and T4). If Sleep Mode 1 is enabled (Yes in Step T2), the entire radio communication system is recovered to the ordinary operation mode by releasing the SNIFF mode or PARK mode, and thereafter executes reproduction (step T3). If Sleep Mode 2 is enabled (Yes in Step T4), the connection is established to recover the entire radio communication system to the ordinary operation mode, and thereafter reproduction is executed (Step T5).

In Sleep Mode 2, although a process for establishing a connection (paging process or the like) is required, reproduction can be started soon after a short delay time for the process, which is negligible to the user. In Sleep Mode 1, since it is unnecessary to carry out the process for establishing a connection, reproduction can be started after a much shorter delay time.

Specific examples of the operations of the power consumption control according to the embodiment will now be described.

<Operation in the case where the music reproduction apparatus is “a master” and the headphone is “a slave”>

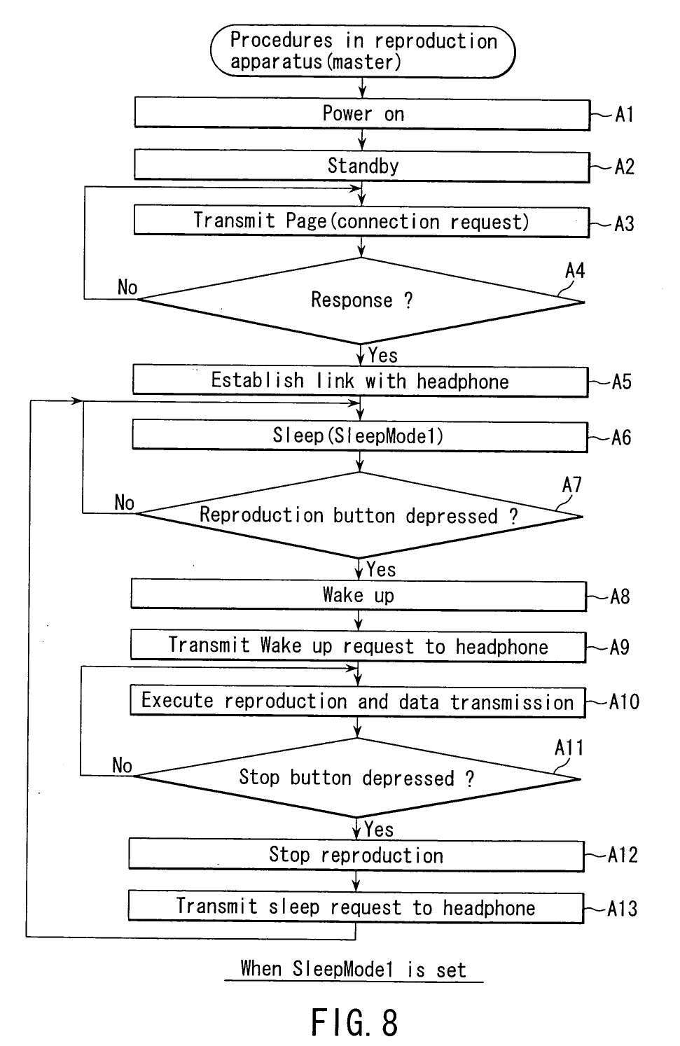

First, an operation in the case where the music reproduction apparatus 1 is a master and the headphone 2 is a slave will be described with reference to the flow charts shown in FIGS. 8 to 11.

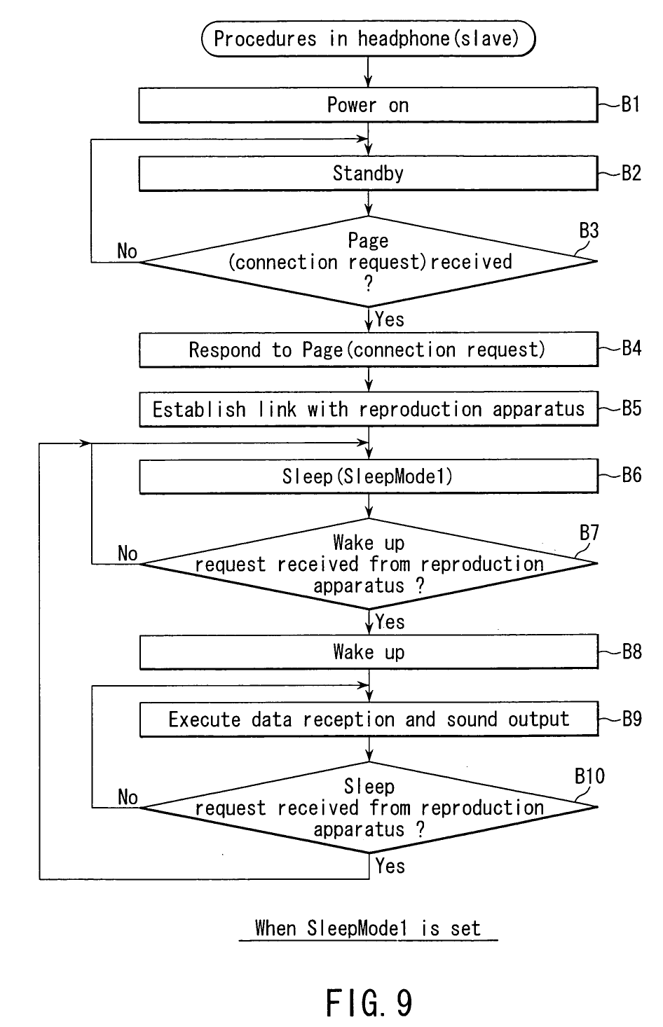

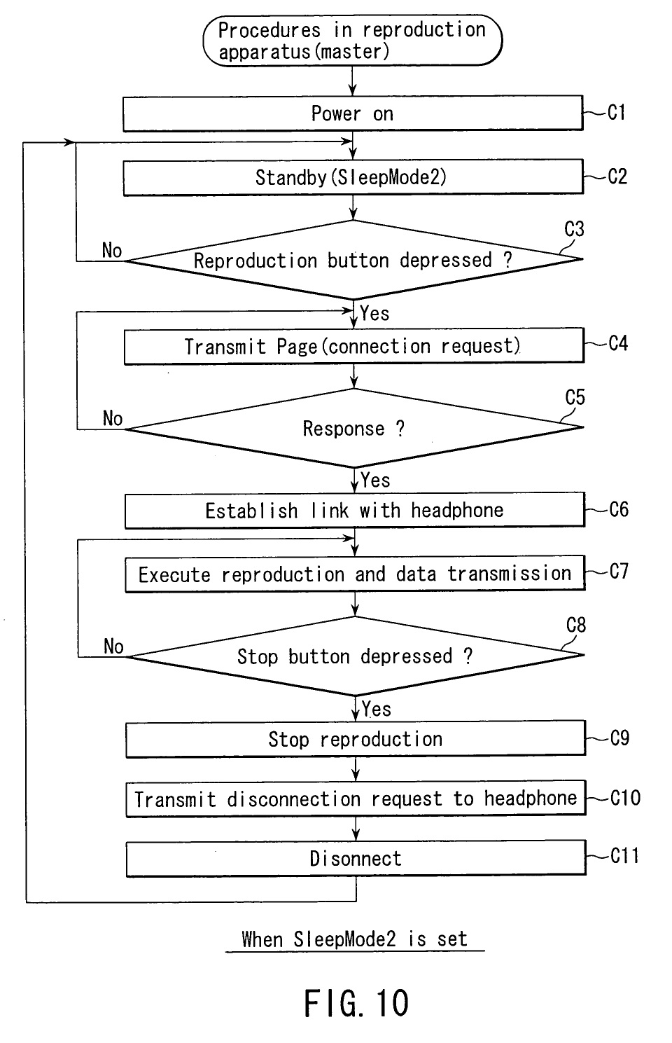

To make the explanation of the operation easier to understand, an operation in the case where Sleep Mode 1 is selectively set is described with reference to FIGS. 8 and 9, and then an operation in the case where Sleep Mode 2 is selectively set is described with reference to FIGS. 10 and 11.

FIG. 8 shows procedures in the music reproduction apparatus (master) when Sleep Mode 1 is set.

When the music reproduction apparatus 1 detects that the power is turned on (Step A1), it is set in the standby mode (Step A2). Thereafter, if necessary, it completes the Inquiry process, and then transmits a page (connection request) (Step A3). If there is any response to the request (Step A4), a link with the headphone 2 is established (Step A5) and the music reproduction apparatus 1 is transitioned to the low-power consumption operation mode “Sleep Mode 1” (Step A6). At this time, the headphone 2 is also transitioned to the low-power consumption operation mode “Sleep Mode 1” automatically (or in response to the command from the music reproduction apparatus 1).

Thereafter, if the reproduction button is depressed (Step A7), the music reproduction apparatus 1 transitions from the low-power consumption operation mode to the ordinary operation mode (Step A8). At the same time, the music reproduction apparatus 1 transmits to the headphone 2 a command that the headphone 2 should recover to the ordinary operation mode (Step A9). Then, it executes an audio data reproduction process and transmits audio data to the headphone 2 (Step A10).

Thereafter, if the stop button or the pause button is depressed (Step A11), the reproduction is stopped (Step A12), and a command that the headphone 2 should enter the Sleep Mode 1 is transmitted to the headphone 2 (Step A13). Then, the procedures from Steps A6 to A13 are repeated.

FIG. 9 shows procedures in the headphone 2 (slave) when Sleep Mode 1 is set.

When the headphone 2 detects that the power is turned on (Step B1), it is set in the standby mode (Step B2). Thereafter, if the headphone 2 receives a page (connection request) from the music reproduction apparatus 1 (Step B3), it responds thereto (Step B4). As a result, a link with the music reproduction apparatus 1 is established (Step B5) and the headphone 2 is transitioned to the low-power consumption operation mode “Sleep Mode 1” (Step B6). At this time, the headphone 2 is transitioned to the low-power consumption operation mode “Sleep Mode 1” automatically (or in response to the command from the music reproduction apparatus 1).

Thereafter, if the headphone 2 receives from the music reproduction apparatus 1 a command that it should recover to the ordinary operation mode (Step B7)(as, for example, by a play command button executed by the user on the operation section 11), it transitions from the low-power consumption operation mode to the ordinary operation mode (Step B8), and receives audio data from the music reproduction apparatus 1 and outputs sound (Step B9).

Thereafter, if the headphone 2 receives from the music reproduction apparatus 1 a command that it should be transitioned to the low-power consumption operation mode “Sleep Mode 1” (Step B10) (as, for example, corresponding to a pause or stop command by the user on the operation section 11), the procedures from Steps B6 to B10 are repeated.

FIG. 10 shows procedures in the music reproduction apparatus (master) when Sleep Mode 2 is set.

When the music reproduction apparatus 1 detects that the power is turned on (Step C1)(e.g., pressing the power on button of the operation section 11), it is set in the standby mode (Step C2).

Thereafter, if the reproduction button is depressed (Step C3)(e.g., by pressing the “play” button on the music reproduction apparatus 1), the music reproduction apparatus 1 completes the Inquiry process. Then, it transmits a page (connection request) (Step C4). If there is any response to the request (Step CS), a link with the headphone 2 is established (Step C6) and the music reproduction apparatus 1 reproduces audio data and sends the audio data to the headphone 2 (Step C7).

Thereafter, if the stop button or the pause button is depressed on the operation section 11 (Step C8), the reproduction is stopped (Step C9), and the music reproduction apparatus 1 transmits to the headphone 2 a disconnection request and a command that the headphone 2 should be transitioned to the low-power consumption operation mode “Sleep Mode 2” (Step C10), and cuts off the connection. Then, the procedures from Steps C2 to C11 are repeated.

FIG. 11 shows procedures in the headphone 2 (slave) when Sleep Mode 2 is set. [00089] When the headphone 2 detects that the power is turned on (Step D1), it is set in the standby mode (Step D2). Thereafter, if the headphone 2 receives a page (connection request) from the music reproduction apparatus 1 (Step D3), it responds thereto (Step D4). As a result, a link with the music reproduction apparatus 1 is established (Step D5) and the headphone 2 receives audio data from the music reproduction apparatus 1 and output sound (Step D6).

Thereafter, if the headphone 2 receives from the music reproduction apparatus 1 a command that it should transition to the low-power consumption operation mode “Sleep Mode 2” (Step D7), (initiated, for example, by a “stop” command actuated on the operation section 11) it cuts off the connection (Step D8) and repeats the procedures from Steps D2 to D8.

<Operation in the case where the headphone is “a master” and the music reproduction apparatus is “a slave”>

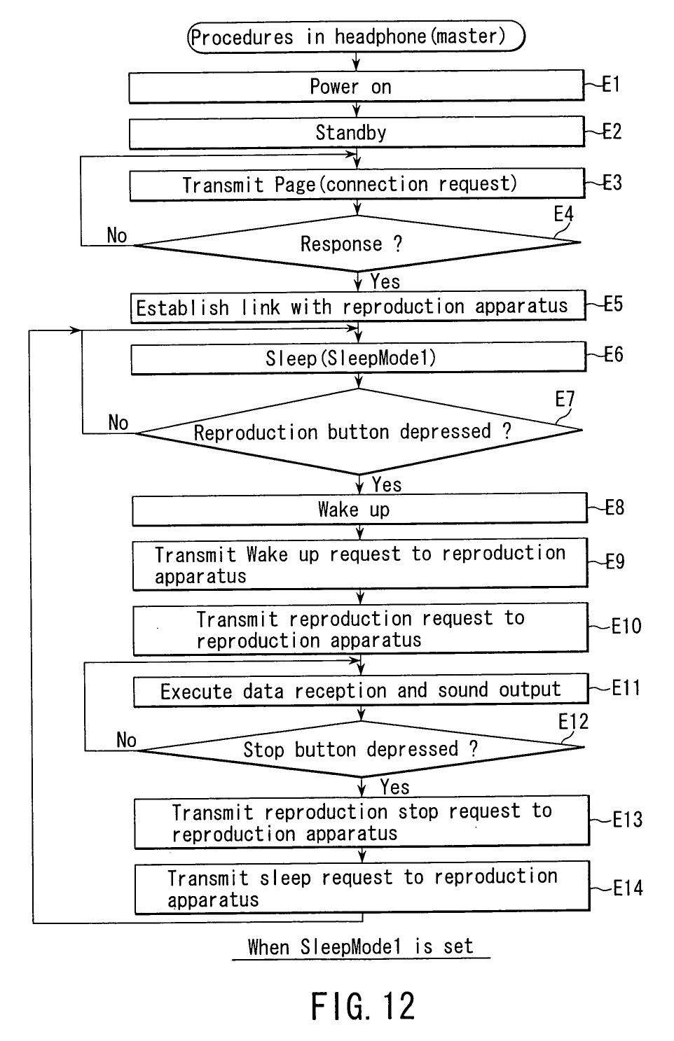

Finally, an operation in the case where the headphone 2 is a master and the music reproduction apparatus 1 is a slave will be described with reference to the flow charts shown in FIGS. 12 to 15.

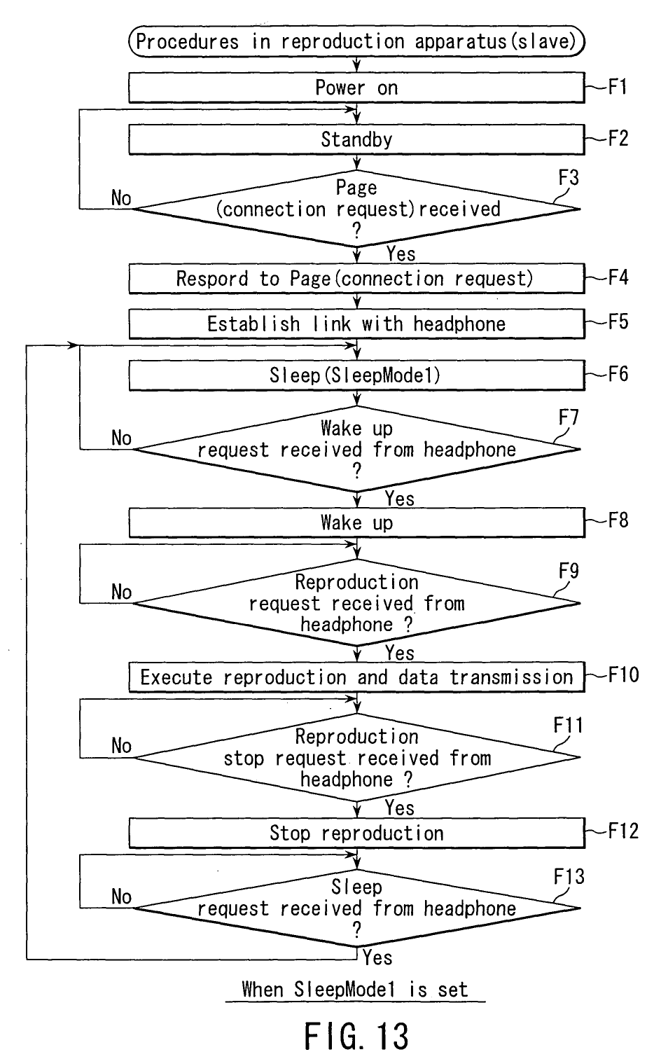

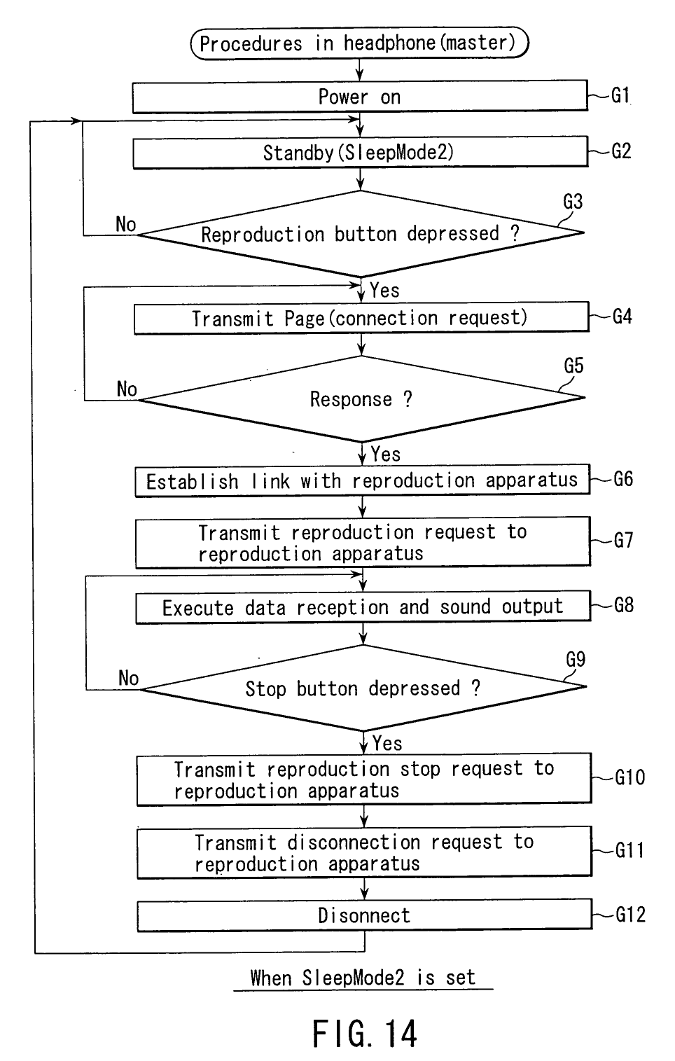

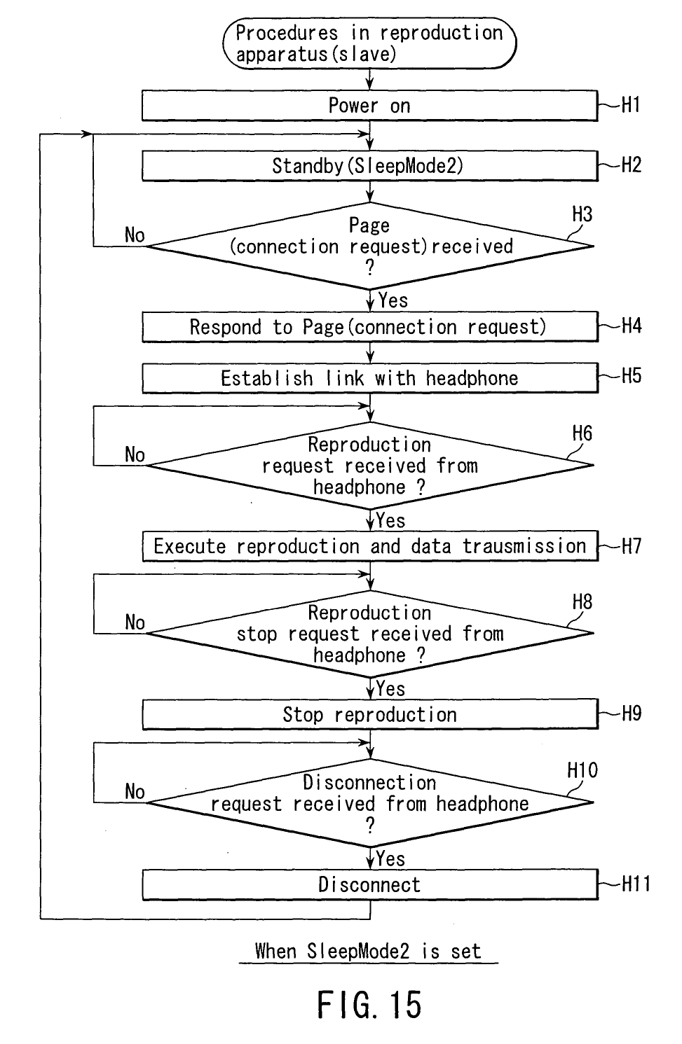

To make the explanation of the operation easier to understand, an operation in the case where Sleep Mode 1 is selectively set is described with reference to FIGS. 12 and 13, and an operation in the case where Sleep Mode 2 is selectively set is described with reference to FIGS. 14 and 15.

FIG. 12 shows procedures in the headphone (master) when Sleep Mode 1 is set. In these embodiments, actuations of the “play” and “stop” commands are performed by the user by actuation of switches on the headphone 2.

When the headphone 2 detects that the power is turned on (Step E1), it is set in the standby mode (Step E2). Thereafter, it completes the Inquiry process, and then transmits a page (connection request) (Step E3). If there is a response thereto (Step E4), a link with the music reproduction apparatus 1 is established (Step E5) and the headphone 2 is transitioned to the low-power consumption operation mode “Sleep Mode 1” (Step E6). At this time, the music reproduction apparatus 1 is also transitioned to the low-power consumption operation mode “Sleep Mode 1” automatically (or in response to the command from the headphone 2).

Thereafter, if the reproduction button is depressed on the headphone 2 (Step E7), the headphone 2 transitions from the low-power consumption operation mode to the ordinary operation mode (Step E8). At the same time, the headphone 2 transmits to the music reproduction apparatus 1 a command that the music reproduction apparatus 1 should recover to the ordinary operation mode (Step E9). Then, it transmits to the music reproduction apparatus 1 a command that a reproduction process should be carried out (Step E10). Then, the headphone 2 receives audio data transmitted from the music reproduction apparatus 1 and outputs sound (Step E11).

Thereafter, if the stop button or the pause button is depressed on the headphone 2 (Step E12), the headphone 2 transmits to the music reproduction apparatus 1 a command that reproduction should be stopped (Step E13), and a command that the music reproduction apparatus 1 should be transitioned to the low-power consumption operation mode “Sleep Mode 1” (Step E14). Then, the procedures from Steps E6 to E14 are repeated.

If the program is constituted such that the music reproduction apparatus 1 is automatically transitioned to the low-power consumption operation mode “Sleep Mode 1” by the procedure in Step E13, Step E14 is unnecessary.

FIG. 13 shows procedures in the music reproduction apparatus 1 (slave) when Sleep Mode 1 is set.

When the music reproduction apparatus 1 detects that the power is turned on (Step F1), it is set in the standby mode (Step F2). Thereafter, if it receives a page (connection request) from the headphone 2 (Step F3), it responds thereto (Step F4). As a result, a link with the headphone 2 is established (Step F5) and the music reproduction apparatus 1 is transitioned to the low-power consumption operation mode “Sleep Mode 1” (Step F6). At this time, the music reproduction apparatus is transitioned to the low-power consumption operation mode “Sleep Mode 1” automatically (or in response to the command from the headphone 2).

Thereafter, if the music reproduction apparatus 1 receives from the headphone 2 a command that it should recover to the ordinary operation mode (Step F7), it transitions from the low-power consumption operation mode to the ordinary operation mode (Step F8). If it receives from the headphone 2 a command that a reproduction process should be carried out (Step F9), it reproduces audio data and transmits the audio data to the headphone 2 (Step F10).

Thereafter, if the music reproduction apparatus 1 receives from the headphone 2 a command that the reproduction should be stopped (Step F11), it stops the reproduction (Step F12). If it receives from the headphone 2 a command it should be transitioned to the low-power consumption operation mode “Sleep Mode 1” (Step F13), the procedures from Steps F6 to F13 are repeated. Alternatively, the Sleep Mode 1 may be entered automatically when the reproduction stop request is received.

FIG. 14 shows procedures in the headphone (master) when Sleep Mode 2 is set.

When the headphone 2 detects that the power is turned on (Step G1), it is set in the standby mode (Step G2).

Thereafter, if the reproduction button is depressed (Step G3), the headphone 2 completes the Inquiry process if necessary. Then, it transmits a page (connection request) (Step G4). If there is any response to the request (Step G5), a link with the music reproduction apparatus 1 is established (Step G6). Then, the headphone 2 transmits to the music reproduction apparatus 1 a command that a reproduction process should be carried out (Step G7), receives audio data transmitted from the music reproduction apparatus 1 and outputs sound (Step G8).

Thereafter, if the stop button or the pause button is depressed on the headphone 2 (Step G9), the headphone 2 transmits to the music reproduction apparatus 1 a command that reproduction should be stopped (Step G10). At the same time, it transmits a disconnection request and a command that the music reproduction apparatus 1 should be transitioned to the low-power consumption operation mode “Sleep Mode 2” (Step G11), and cuts the connection (Step G12). Then, the procedures from Steps G2 to G12 are repeated.

The music reproduction apparatus 1 may be programmed to automatically cut off the connection and transition to the low-power consumption operation mode “Sleep Mode 1” by the procedure in Step G10, in which case, Step G11 is unnecessary.

FIG. 15 shows procedures in the music reproduction apparatus 1 (slave) when Sleep Mode 2 is set.

When the music reproduction apparatus 1 detects that the power is turned on (Step H1), it is set in the standby mode (Step H2). Thereafter, if it receives a page (connection request) from the headphone 2 (Step H3), it responds thereto (Step H4). As a result, a link with the headphone 2 is established (Step H5). Thereafter, if the music reproduction apparatus 1 receives from the headphone 2 a command that a reproduction process should be carried out (Step H6), it reproduces audio data and transmits the audio data to the headphone 2 (Step H7).

Then, if the music reproduction apparatus 1 receives from the headphone 2 a command that the reproduction should be stopped (Step H8), it stops the reproduction (Step H9). If it receives from the headphone 2 a disconnection request and a command that it should be transitioned to the low-power consumption operation mode “Sleep Mode 2” (Step H10), it cuts off the connection (Step H11), and the procedures from Steps H2 to H11 is repeated. The stop command of step H9 may automatically cause execution of step H11 in which case step H10 is omitted.

As has been described, according to the above embodiment, there is provided a connection-type radio communication system including the music reproduction apparatus 1 capable of reproducing audio data and the headphone 2 capable of outputting sound based on the reproduced audio data, wherein the power consumption of the overall system can be reduced, while ease of the operation of the music reproduction apparatus 1 and the headphone 2 is maintained.

For example, in the above embodiment, the same low-power consumption operation mode is set in both the music reproduction apparatus 1 and the headphone 2. However, different low-power consumption operation modes can be set therein. Alternatively, the low-power consumption operation mode can be set in either the music reproduction apparatus 1 or the headphone 2.

It is noted that generally, the master unit, whether it be the music reproduction or the headset, is the unit the user will normally use in depressing the “play”, “pause” or “stop” buttons or setting these function by means of some actuation mechanism on the master unit. However, even in such case, according to other embodiments of the invention, duplicate buttons or duplicate actuation mechanism are provided on the slave unit. In such case, a “play” or “stop” command may be initiated by the user depressing the “play” or “stop” button on the slave and, in the Sleep Mode 1, a signal is sent from the slave to the master. In the case of the “play” command, the signal causes the master unit to send a wake up request to the slave as in the previously described processes (e.g., step B7-8; or E7-8). In the case of a stop command, the signal sent from the slave to the master causes the master to transmit a stop command as in the cases described above (steps B10, E12-13, C8-9). However, if the master and slave are in the Sleep Mode 2, actuation on a “play” command on the slave will cause the slave unit to become the master unit since communications links are disconnected in the Sleep Mode 2 and must be re-established.

Further, when the system is transitioned from the ordinary power consumption operation mode to the low-power consumption operation mode or transitions from the low-power consumption operation mode to the ordinary power consumption operation mode, it may notify the user with a beep or the like.

It is also possible for either of both of the headphone 2 and the music reproduction apparatus 1 to have a timer which may be set by the user or factory set. The timer will automatically cause entry into either Sleep Mode 1 or Sleep Mode 2 upon the expiration of the set time. It is also possible to have the timer function deactivated by the user.

It is further noted that the “ordinary operation mode” is generally the mode of operation in which content data is being transmitted from the music reproduction apparatus 1 to the headphone 2. If this mode was preceded by a low-power consumption mode, there will be always a high-power mode initiated just prior to transmission of content data. The ordinary operation mode may also be understood to include this period of time in which the increase of power has taken place.

In the above embodiment, audio data is used as a kind of content data. However, the present invention is not limited to this embodiment, and video data may be used instead of audio data. In this case, it is only necessary that the combination of a music reproduction apparatus and a headphone is replaced by the combination of an image reproduction apparatus and an image output apparatus. Further, it is possible to use both audio data and video data.

As has been described above, according to the present invention, power consumption can be reduced, while ease of the operation is maintained.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A power consumption control method applied to a communication system including a reproduction apparatus capable of reproducing content data and an output apparatus capable of outputting data based on the reproduced content data, the method comprising:
transmitting the content data reproduced by the reproducing apparatus to the output apparatus through a radio communication interface in an ordinary operation mode; and
transitioning at least one of the reproducing apparatus and the output apparatus from said ordinary operation mode to a low-power consumption operation mode through the radio communication interface, when a data reproduction stop request is made in another of the reproducing apparatus and the output apparatus.

2. The power consumption control method according to claim 1, wherein when the data reproduction stop request is made in the output apparatus, the reproduction apparatus is transitioned to the low-power consumption operation mode through the radio communication interface and the output apparatus is transitioned to the low-power consumption operation mode.

3. The power consumption control method according to claim 2, wherein when a data reproduction request is made in the output apparatus, the output apparatus is recovered from the low-power consumption operation mode to the ordinary operation mode and the reproduction apparatus is recovered from the low-power consumption operation mode to the ordinary operation mode through the radio communication interface.

4. The power consumption control method according to claim 1, wherein when the data reproduction stop request is made in the reproduction apparatus, the output apparatus is transitioned to the low-power consumption operation mode through the radio communication interface and the reproduction apparatus is transitioned to the low-power consumption operation mode.

5. The power consumption control method according to claim 4, wherein when the data reproduction stop request is made in the reproduction apparatus, the reproduction apparatus is recovered from the low-power consumption operation mode to the ordinary mode, and the output apparatus is recovered from the low-power consumption operation mode to the ordinary operation mode through the radio communication interface.

6. The power consumption control method according to claim 1, wherein the low-power consumption operation mode is a state in which power consumption relating to radio communication is reduced.

7. The power consumption control method according to claim 6, wherein the low-power consumption operation mode includes a first mode in which connection of the radio communication is maintained and a second mode in which the connection is cut off.

8. The power consumption control method according to claim 7, wherein when a data reproduction request is made in one of the reproducing apparatus and the output apparatus, if the connection of the radio communication has been cut off, the connection of the radio communication is established and the other of the reproduction and the output apparatus is recovered from the low-power consumption operation mode to the ordinary operation mode.

9. An output apparatus, comprising:
a radio communication interface;
an output control unit configured to output data in accordance with content data transmitted from a reproduction apparatus through the radio communication interface; and
a power control unit configured to control at least the reproduction apparatus to transition from an ordinary operation mode in which content data is transmitted to a low-power consumption operation mode through the radio communication interface, when a data reproduction stop request is made at the output apparatus.

10. The output apparatus according to claim 9, wherein the power control unit transitions the output apparatus to the low-power consumption operation mode, when the data reproduction stop request is made.

11. The output apparatus according to claim 10, wherein the power control unit transitions the output apparatus from the low-power consumption operation mode to the ordinary operation mode, and the reproduction apparatus from the low-power consumption operation mode to the ordinary operation mode through the radio communication interface, when a data reproduction request is made.

12. The output apparatus according to claim 9, wherein the low-power consumption operation mode is a state in which power consumption relating to radio communication is reduced as compared to the ordinary operation mode.

13. The output apparatus according to claim 12, wherein the low-power consumption operation mode includes a first mode in which connection of the radio communication is maintained and a second mode in which the connection is cut off.

14. A reproduction apparatus, comprising:
a radio communication interface;
a reproduction control unit configured to reproduce content data;
a transmission control unit configured to transmit the content data reproduced by the reproduction control unit to an output apparatus through the radio communication interface; and
a power control unit configured to control at least the output apparatus to transition from an ordinary operation mode in which content data is transmitted, to a low-power consumption operation mode through the radio communication interface, when a data reproduction stop request is made at the reproduction apparatus.

15. The reproduction apparatus according to claim 14, wherein the power control unit transitions the reproduction apparatus to the low-power consumption operation mode, when the data reproduction stop request is made.

16. The reproduction apparatus according to claim 15, wherein the power control unit transitions the reproduction apparatus from the low-power consumption operation mode to the ordinary operation mode, and the output apparatus from the low-power consumption operation mode to the ordinary operation mode through the radio communication interface, when a data reproduction request is made.

17. The reproduction apparatus according to claim 14, wherein the low-power consumption operation mode is a state in which power consumption relating to radio communication is reduced.

18. The reproduction apparatus according to claim 17, wherein the low-power consumption operation mode includes a first mode in which connection of the radio communication is maintained and a second mode in which the connection is cut off.
